(19) United States
(12) Patent Application Publication
(10) Pub. No.: US 2008/0034598 A1
(43) Pub. Date: Feb. 14, 2008

(54) Positioning system for use in a football game

(76) Inventor: Joe S. Boccardi, Fenton, MO (US)

Correspondence Address: HARSHAW RESEARCH, INC., 210 W. TECUMSEH STREET, OTTAWA, KS, 66067, US

(21) Appl. No.: 11/503,610

(22) Filed: Aug. 14, 2006

(51) Int. Cl. G01C 15/00

(52) U.S. Cl. 33/289

(57) ABSTRACT

A positioning system for use on a football field includes a plurality of stationary devices for positioning about a football field, each stationary device having a transmitter and receiver. The system includes a spotting device having a transmitter, receiver, and display. The system includes a first marking device having a receiver, transmitter, and display. A processor is in data communication with at least one stationary device and the stationary device is in data communication with the first marking device and spotting device. These devices are able to determine, communicate, and display actual spotter device (ball) position, ideal spotter (ball) position, and marker position. Together, this enables a referee to spot a football and determine first down yardage without the traditional use of markers and chains. The spotter device may be placed adjacent the nose of a football and the display communicates if the ball should be moved forward or backward.

### BACKGROUND OF THE INVENTION

This invention relates generally to tracking and positioning systems and, more particularly, to a positioning system for use in a football game. The system enables a referee to accurately and efficiently position a ball and to measure and mark first downs.

Accurately measuring and marking first downs during a football game is a difficult and time-consuming task. Traditionally, football referees must use a pair of markers connected by a chain to measure an appropriate mark that a football must be advanced to be granted a first down. Whenever the football is advanced close to that mark, the chain and markers may need to be carried onto the field in order to determine if the first down was, in fact, reached. Another issue of measuring difficulty is when an incomplete pass is thrown and the ball must be returned to the exact point of a previous spot. Properly positioning a ball after a penalty is assessed may also introduce ball placement inaccuracies. As these ball placements necessarily require an amount of subjective decision making by the referees, inaccurate ball placements are common.

Various devices and systems have been proposed in the prior art for measuring and determining first downs and accurate ball placements. More particularly, systems for determining if a first down has been achieved or for determining correct ball position include lasers, are mounted on a carriage or on a first down marker itself, and provide for emitting a laser beam across the field of play. Although assumably effective for their intended purposes, the existing systems either depend upon the correct positioning of a sideline accessory, e.g. the first down marker, carriage, or the like, or require an additional target to be positioned on the field onto which the laser beam is projected. These systems further require special accommodation for shaping the laser beam on account of the rising slope of the field.

Therefore, it would be desirable to have a positioning system that enables football referees to accurately, easily, and efficiently determine a first down position as well as a ball position without the traditional use of markers and chains. Further, it would be desirable to have a positioning system that utilizes multiple transmitters and receivers to calculate measurements and to visually indicate when a ball has been correctly positioned on the field. In addition, it would be desirable to have a positioning system in which a referee needs only to carry and use a small spotter device that is in communication with a plurality of receivers positioned at stationary and predetermined locations about the field of play.

### SUMMARY OF THE INVENTION

A positioning system for use on a football field includes at least three stationary devices with each stationary device having a stationary transmitter and receiver. The system includes a spotting device having a spotting receiver, a spotting transmitter, and a display. Further, the system includes a first marking device having a first marking receiver, a first marking transmitter, and a first marking display. The stationary devices, spotting device, and first marking device transmit and receive ideal spotter position data, actual spotter position data, and first marker position data. A processor is in data communication with each stationary device and includes programming for determining ideal spotter position data and ideal first marker position data. The processor also includes programming for actuating the at least one stationary transmitter to transmit ideal spotter position data and the ideal first marker position data.

Determinations by the processor, transmission of data between the component devices, and displaying this respective data on the spotting device display and marker displays enables a referee to properly position a ball on the football field after each down, after an incomplete pass, after a penalty has been assessed, etc. This is accomplished through data communication between the system components and the processor. The processor is able to triangulate data from the stationary devices to determine ideal spotter position data. The spotting device, on the other hand, transmits actual ball location to the stationary devices. Put simply, the idea spotter position data represents where the spotter device (and the ball) should be and the actual position data (determined by the spotter device in communication with the stationary devices) represents where the ball is actually located.

Therefore, a general object of this invention is to provide a positioning system for accurately determining a first down marking in a football game and for accurately positioning a football.

Another object of this invention is to provide a positioning system, as aforesaid, that enables a referee to accurately determine a first down position without carrying or using traditional markers and chains.

Still another object of this invention is to provide a positioning system, as aforesaid, that enables football referees to easily and efficiently position a football after every down.

Yet another object of this invention is to provide a positioning system, as aforesaid, that triangulates the position of a ball using a spotting device and receivers previously positioned about a football field.

A further object of this invention is to provide a positioning system, as aforesaid, in which a spotting device visually indicates when a ball is properly positioned relative to a previously determined first down measurement.

A still further object of this invention is to provide a positioning system, as aforesaid, in which first down markers transmit signals to the receivers for determining their position on the field so as to calculate an offset, e.g. a first down position.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a marker device according to a preferred embodiment of the present invention;

FIG. 1b is an isolated view on an enlarged scale taken from FIG. 1a;

FIG. 1c is a sectional view taken along line 1c-1c of FIG. 1a;

FIG. 2a is a perspective view of a spotter device according to a preferred embodiment of the present invention, the spotter device display indicating that the ball is correctly positioned;

FIG. 2b is a front view of the spotter device as in FIG. 2a but indicating the actual position of the ball is not yet correct;

FIG. 3 is a block diagram of a positioning system according to a preferred embodiment of the present invention;

FIG. 4 is a schematic drawing of a positioning system according to the preferred embodiment of the present invention, illustrating use of the spotter device; and

FIG. 5 is another schematic drawing of the positioning system as in FIG. 4, illustrating use of the marker devices.

### DESCRIPTION OF THE PREFERRED EMBODIMENT

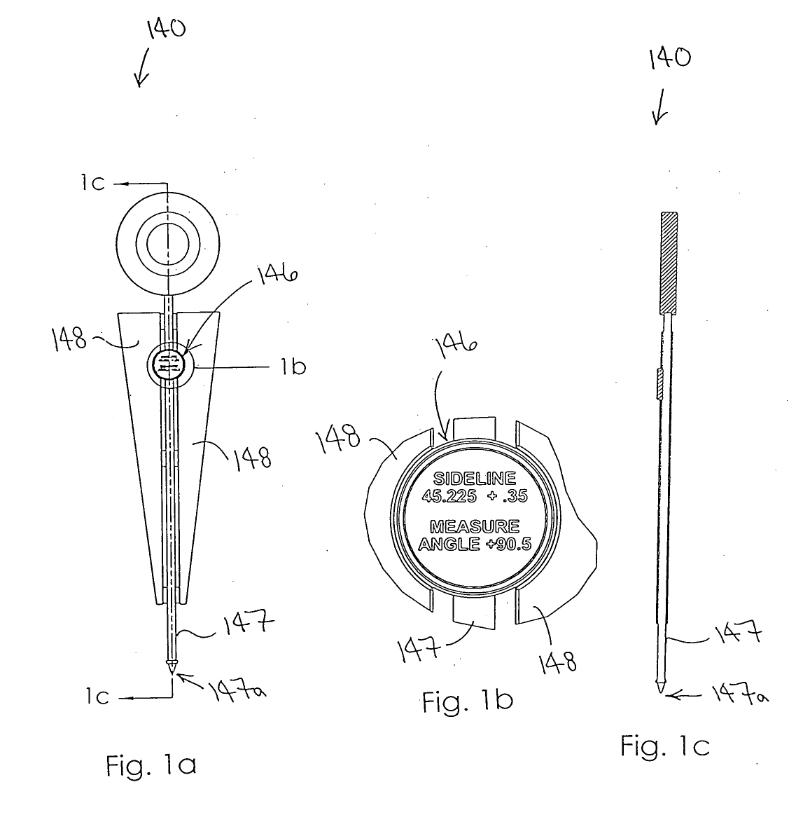

A positioning system 100 for use in a football game according to the present invention will now be described in detail with reference to FIGS. 1a through 5 of the accompanying drawings. More particularly, a positioning system 100 according to the current invention includes a plurality of stationary devices 110 and a spotting device 120.

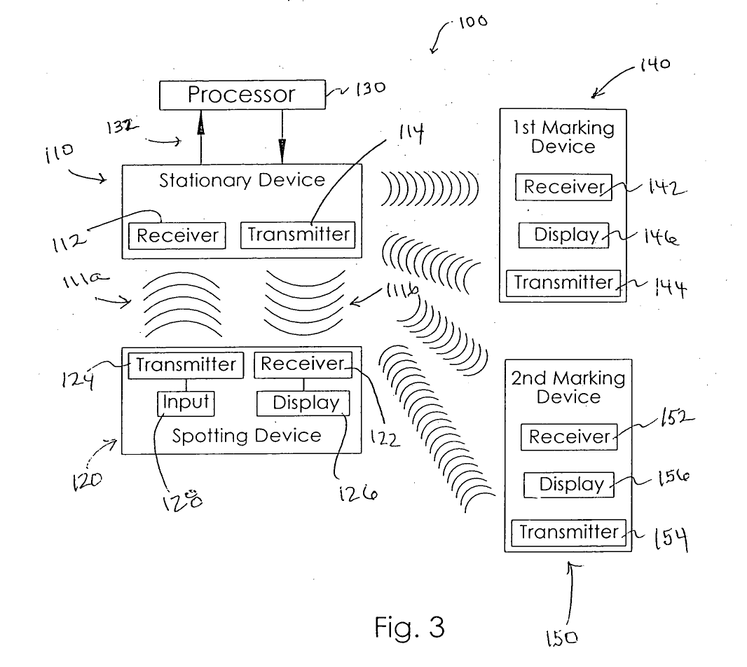

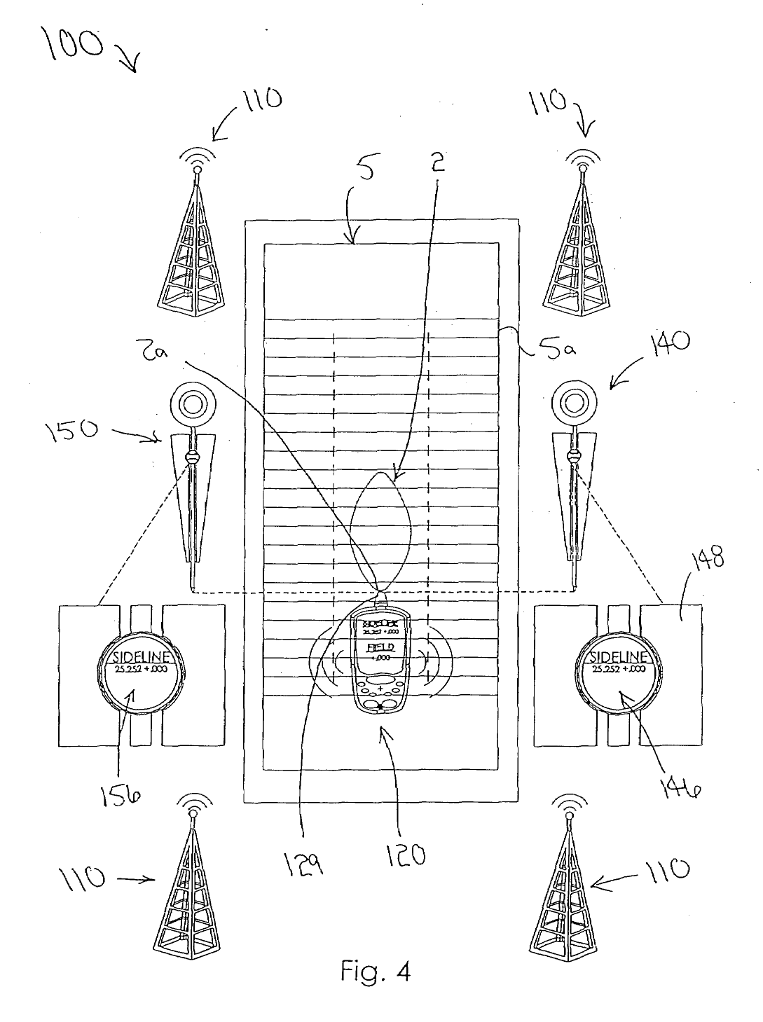

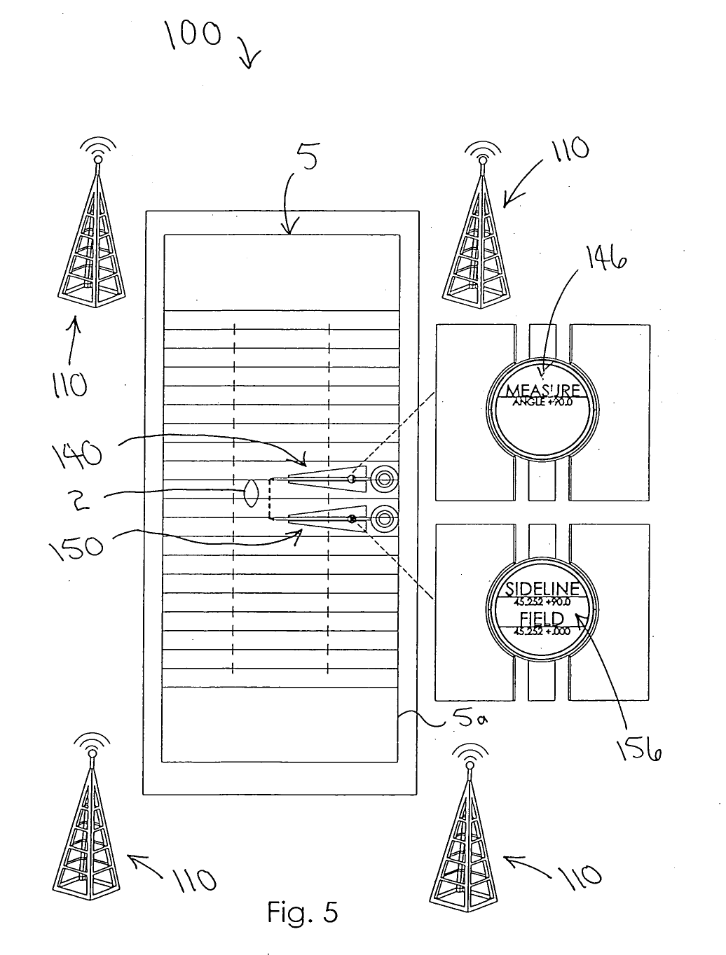

At least three stationary devices 110 are preferably included, and as shown in FIGS. 4 and 5, the system 100 may include more than three stationary devices 110. Each stationary device 110 has a respective receiver 112 (also referred to herein as a “stationary receiver”), and at least one of the stationary devices 110 has a respective transmitter 114 (also referred to herein as a “stationary transmitter”) (FIG. 3).

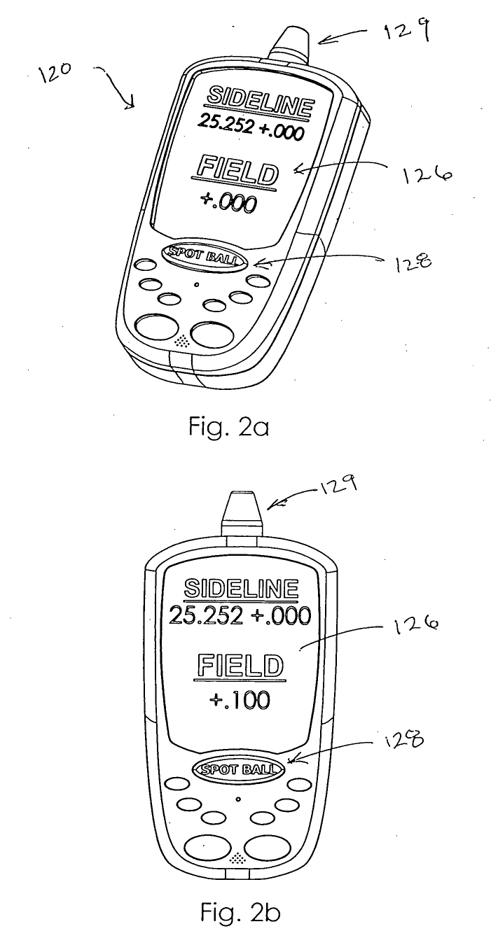

The spotting device 120 (FIGS. 2a-4) has a receiver 122 (also referred to herein as a “spotting receiver”) for receiving ideal spotter position data from at least one stationary transmitter 114, a transmitter 124 (also referred to herein as a “spotting transmitter”) for transmitting actual spotter position data to each stationary device 110, and a display 126 (also referred to herein as a “spotting display”) for displaying the ideal spotter position data and the actual spotter position data. The actual spotter position data represents the actual location of the spotting device 120, and the ideal spotter position data represents where the spotting device 120 should be in accordance with the rules of football. Actual spotter position data is labeled 111a in FIG. 3; ideal spotter position data is labeled 111b in FIG. 3. The spotting display 126 may display the ideal spotter position data and the actual spotter position data as a difference between the ideal spotter position data and the actual spotter position data (FIGS. 2a and 2b), or the spotting display 126 may simply display both the ideal spotter position data and the actual spotter position data. The spotting device 120 may include a user input 128 in data communication with the spotting transmitter 124 for selectively actuating the spotting transmitter to transmit the actual spotter position data, and/or the spotting device 120 may include a nose cup 129 complementary to a nose 2a of a football 2 (FIG. 4). The user input 128 may be a keypad, for example, and/or the user input 128 may be a pressure switch connected to the nose cup 129.

A processor 130 may be in data communication with each stationary receiver 112 for obtaining the actual spotter position data from the stationary device 110. The processor 130 may have a receiver in communication with the stationary transmitters 114, or the processor 130 may be physically connected to the stationary receivers (e.g., by data cables). Arrows 132 in FIG. 3 represent the data communication between the processor 130 and a respective stationary device 110. The processor 130 may include programming for determining the ideal spotter position data (i.e., by triangulation) and actuating at least one stationary transmitter 114 to transmit the ideal spotter position data to the spotting receiver 122.

A first marking device 140 may have a receiver 142 (also referred to herein as a “first marking receiver”) for receiving ideal first marker position data from at least one stationary transmitter 114, a transmitter 144 (also referred to herein as a “first marking transmitter”) for transmitting actual first marker position data to each stationary device 110, and a display 146 (also referred to herein as a “first marking display”) for displaying the ideal first marker position data and the actual first marker position data. The actual first marker position data represents the actual location of the first marking device 140, and the ideal first marker position data represents where the first marking device 140 should be in accordance with the rules of football. The first marking device 140 is preferably physically separate from the stationary devices 110 and the spotting device 120, and the first marking device 140 may be an elongate sign as shown in FIGS. 1b and 1c. More particularly, the first marking device 140 may have an elongate member 147 flanked by a pair of visibility-enhancing projections 148, and the elongate member 147 and/or the projections 148 may have visibility-enhancing indicia (e.g., brightly colored paint). The elongate member 147 may have a lower end 147a, and the first marking display 146 may be coupled to the elongate member 147 so that the first marking display 146 is between four feet and six feet from the lower end 147a of the elongate member 147 so that the first marking display 146 may be easily viewed when the elongate member 147 is stood upright.

The processor 130 may have programming for determining the ideal first marker position data (i.e., by triangulation) and actuating at least one stationary transmitter 114 to transmit the ideal first marker position data to the first marking receiver 142. The processor 130 may additionally or alternately have programming for determining first marker angle data using the actual first marker position data and the ideal first marker position data and actuating at least one stationary transmitter 114 to transmit the first marker angle data for display on the first marking display 146. First marker angle data may correspond to the angle that the first marking device 140 deviates from ninety degrees when considering a sideline as one line and a line connecting the first marking device 140 and a point corresponding to the correct position of the ball as the other relevant line.

A second marking device 150 may have a receiver 152 (also referred to herein as a “second marking receiver”) for receiving ideal second marker position data from at least one stationary transmitter 114, a transmitter 154 (also referred to herein as a “second marking transmitter”) for transmitting actual second marker position data to each stationary device 110, and a display 156 (also referred to herein as a “second marking display”) for displaying the ideal second marker position data and the actual second marker position data. The actual second marker position data represents the actual location of the second marking device 150, and the ideal second marker position data represents where the second marking device 150 should be in accordance with the rules of football. The second marking device 150 is preferably physically separate from the stationary devices 110 and the spotting device 120, and the second marking device 140 may be an elongate sign as shown in FIGS. 4 and 5. The second marking device 150 may or may not be substantially similar to the first marking device 140. The processor 130 may have programming for determining the ideal second marker position data (i.e., by triangulation) and actuating at least one stationary transmitter 114 to transmit the ideal second marker position data to the second marking receiver 142.

In use, the stationary devices 110 may be positioned at predetermined points about a football field 5 (FIGS. 4 and 5) and initiated or calibrated as to their positions relative to the field. The spotting device 120 may be used to indicate where a ball is located after a play by sending actual spotter position data to the stationary devices 110 which is in data communication with the processor 130 as described above, and the spotting device 120 may then be used to reposition the ball correctly in the center of the field using the ideal spotter position data from the processor 130. More particularly, a user may position the ball correctly by following the information provided on the spotting display 126. For example, the spotting display 126 will indicate a positive or negative distance that the ball needs to be moved on the field to be at the correct position (FIG. 2b). Each time the referee places the nose cup 129 at the nose of the football 2 and actuates the input button 128, the display 126 will again show if the ball needs to be moved in a positive or negative longitudinal direction on the field. When properly positioned, the spotter device display will indicate +0.000 under the Field position indicator (FIG. 2a).

The spotting device 120 may also be used in a similar manner to adjust a ball's location due to a penalty, in the event of an incomplete pass, etc. For example, when a 10-yard penalty is assessed or a penalty calling for half the distance to the goal line is assessed, the processor 130 and stationary devices 110 may cooperate to determine where the ball should be placed. Actual data from the spotter device 120 may then be used to assist the referee in accurately placing the ball at just the right spot.

The first and second marking devices 140, 150 may communicate with the processor 130 as described above so that the first and second marking devices 150 are placed appropriately along a sideline 5a (FIG. 5) to indicate, for example, the current line of scrimmage and the first down line in accordance with the rules of football. More particularly, users may position the first and second marking devices 140, 150 correctly by following the information provided on the first and second marker displays 146, 156. With specific reference to FIG. 1b, the processor 130 has determined the proper line of scrimmage and caused it to be displayed on the marker display 146. Also displayed is the distance that the marker still needs to be moved to be properly aligned with the line of scrimmage, e.g. 0.35. The angle measurement is also displayed such that the markers may be placed in perfect 90 degree angle alignment for accurate measurements to be sent to the processor 130. As shown in FIG. 4, the second marking device 150 may perform substantially similar to the first marking device 140 on an opposite side of the football field 5 to act as a backup should the first marking device 140 fail for any reason.

It is understood that while certain forms of this invention have been illustrated and described, it is not limited thereto except insofar as such limitations are included in the following claims and allowable functional equivalents thereof.

What is claimed is as follows:

1. A positioning system for use in a football game, said system comprising:
at least three stationary devices, each stationary device having a respective stationary receiver and a respective stationary transmitter;
a spotting device having a spotting receiver for receiving ideal spotter position data from at least one said stationary transmitter, a spotting transmitter for transmitting actual spotter position data to each said stationary device, and a spotting display for displaying said ideal spotter position data and said actual spotter position data;
a first marking device having a first marking receiver for receiving ideal first marker position data from at least one said stationary transmitter, a first marking transmitter for transmitting actual first marker position data to each said stationary device, and a first marking display for displaying said ideal first marker position data and said actual first marker position data; and
a processor in data communication with each said stationary device for receiving said actual spotter position data and said actual first marker position data, said processor having programming for determining said ideal spotter position data and said ideal first marker position data, said processor having programming for actuating at least one said stationary transmitter to transmit said ideal spotter position data and said ideal first marker position data.

2. The system of claim 1, wherein said spotting display displays said ideal spotter position data and said actual spotter position data as a difference between said ideal spotter position data and said actual spotter position data.

3. The system of claim 1, wherein said spotting device includes a user input in data communication with said spotting transmitter for selectively actuating said spotting transmitter to transmit said actual spotter position data.

4. The system of claim 1, wherein said spotting device includes a nose cup having a configuration complementary to a configuration of a nose of a football.

5. The system of claim 1, wherein:
said processor has programming for determining first marker angle data using said actual first marker position data and said ideal first marker position data; and
said processor has programming for actuating at least one said stationary transmitter to transmit said first marker angle data for display on said first marking display.

6. The system of claim 1, wherein said first marking device is an elongate sign having visibility-enhancing indicia.

7. The system of claim 1, wherein said fist marking device is an elongate sign having a visibility-enhancing projection.

8. The system of claim 1, further comprising:
a second marking device having a second marking receiver for receiving ideal second marker position data from at least one said stationary transmitter, a second marking transmitter for transmitting actual second marker position data to each said stationary device, and a second marking display for displaying said ideal second marker position data and said actual second marker position data; and
wherein said processor has programming for determining said ideal second marker position data and programming for actuating at least one said stationary transmitter to transmit said ideal second marker position data.

9. A positioning system for use in a football game, said system comprising:
at least three stationary devices, each stationary device having a respective stationary receiver, at least one said stationary device having a respective stationary transmitter;
a spotting device having a spotting receiver for receiving ideal spotter position data from at least one said stationary transmitter, a spotting transmitter for transmitting actual spotter position data to each said stationary device, and a spotting display for displaying said ideal spotter position data and said actual spotter position data; and
a processor in data communication with each said stationary receiver for obtaining said actual spotter position data, said processor having programming for determining said ideal spotter position data and actuating said at least one stationary transmitter to transmit said ideal spotter position data to said spotting receiver.

10. The system of claim 9, wherein said spotting device includes a user input in data communication with said spotting transmitter for selectively actuating said spotting transmitter to transmit said actual spotter position data.

11. The system of claim 10, wherein said spotting device includes a nose cup complementary to a nose of a football.

12. The system of claim 9, wherein said spotting display displays said ideal spotter position data and said actual spotter position data as a difference between said ideal spotter position data and said actual spotter position data.

13. The system of claim 9, wherein said spotting device includes a nose cup complementary to a nose of a football.

14. The system of claim 9, further comprising:
a first marking device physically separate from said stationary devices and said spotting device;
and wherein:
said first marking device has a first marking receiver for receiving ideal first marker position data from said at least one said stationary transmitter;
said first marking device has a first marking transmitter for transmitting actual first marker position data to each said stationary device;
said first marking device has a first marking display for displaying said ideal first marker position data and said actual first marker position data; and
said processor has programming for determining said ideal first marker position data and actuating said at least one stationary transmitter to transmit said ideal first marker position data to said first marking receiver.

15. The system of claim 14, wherein said first marking device is an elongate sign having at least one item selected from the group consisting of visibility-enhancing indicia and a visibility-enhancing projection.

16. The system of claim 15, wherein said spotting device includes a nose cup complementary to a nose of a football.

17. The system of claim 14, wherein:
said processor has programming for determining first marker angle data using said actual first marker position data and said ideal first marker position data; and
said processor has programming for actuating said at least one stationary transmitter to transmit said first marker angle data for display on said first marking display.

18. The system of claim 14, wherein:
a second marking device has a second marking receiver for receiving ideal second marker position data from at least one said stationary transmitter, a second marking transmitter for transmitting actual second marker position data to each said stationary device, and a second marking display for displaying said ideal second marker position data and said actual second marker position data; and
said processor has programming for determining said ideal second marker position data and programming for actuating said at least one stationary transmitter to transmit said ideal second marker position data.

19. The system of claim 14, wherein:
said first marking device has an elongate member flanked by a pair of visibility-enhancing projections;
said elongate member has a lower end; and
said first marking display is coupled to said elongate member so that said first marking display is between four feet and six feet from said elongate member lower end.
